(19) United States
(12) Patent Application Publication
(10) Pub. No.: US 2024/0160452 A1
(43) Pub. Date: May 16, 2024

(54) SYSTEM, DEVICES AND/OR PROCESSES FOR RUNTIME LINKING OF SOFTWARE COMPONENT FUNCTION IMPLEMENTATIONS

(71) Applicant: Arm Limited, Cambridge (GB)

(72) Inventors: Eric Van Hensbergen, Austin, TX (US); Vasileios Laganakos, Saffron Walden (GB); Pavel Shamis, Austin, TX (US); Luis Emilio Pena, Austin, TX (US)

(21) Appl. No.: 18/080,531

(22) Filed: Dec. 13, 2022

(30) Foreign Application Priority Data
Nov. 14, 2022 (EP) 22386081.8

(51) Int. Cl. G06F 9/445

(52) U.S. Cl. CPC G06F 9/44521

(57) ABSTRACT

The present disclosure relates generally to systems, devices and/or processes for runtime linking of software component function implementations, and relates more particularly to linking particular function implementations based at least in part on a current execution environment.

### BACKGROUND

### Field

The present disclosure relates generally to systems, devices and/or processes for runtime linking of software component function implementations, and relates more particularly to linking particular function implementations based at least in part on a current execution environment.

### Information

Today's computing systems are increasingly heterogenous, distributed and/or complex, with different hardware and/or software architectures and/or with software application workflows spread out across different hosts in a network, for example. The World Wide Web (or simply the Web), provided by the Internet, for example, is growing rapidly, at least in part, from the large amount of content being added on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like.

Additionally, computing devices, such as IoT-type devices, for example, may incorporate a variety of processing circuits including general-purpose central processing units (CPU) and/or microcontrollers, machine learning (ML) accelerators, graphics processing units (GPU), etc. ML, for example, appears to be increasingly prevalent throughout the computing industry. To address this surge of interest in ML, more and more systems appear to be including hardware-based ML accelerators and/or the like. Further, processors (e.g., CPUs, GPUs, ML accelerators, etc.) may incorporate a number of execution cores of varying capabilities, for example. In some instances, challenges may be faced in developing software applications capable of improved performance, efficiency and/or security, for example, across such a variety of execution environments.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an embodiment of an example system including one or more server computing devices and/or one or more client computing devices;

FIG. 2 is a schematic block diagram depicting an embodiment of an example client computing device, such as an Internet of Things (IoT) type device;

FIG. 3 depicts a schematic block diagram depicting an example software component compilation approach, in accordance with an embodiment;

FIG. 4 is an illustration depicting an example software component linking approach, in accordance with an embodiment;

FIG. 5 is a flow chart depicting an example software component linking process, in accordance with an embodiment;

FIG. 6 is a flow chart illustrating an example software component dynamic linking process, in accordance with an embodiment;

FIG. 7 is a flow chart depicting example software component dynamic linking process, in accordance with an embodiment;

FIG. 8 is a flow chart illustrating an example process for selecting a particular implementation of a particular function, in accordance with an embodiment;

FIG. 9 is a schematic block diagram illustrating an example approach for dynamically linking particular implementations of particular functions, in accordance with an embodiment;

FIG. 10 depicts a schematic block diagram depicting an example edge computing environment, in accordance with an embodiment; and

FIG. 11 depicts a schematic diagram illustrating an implementation of an example computing and/or communications environment, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned above, today's computing systems are increasingly heterogenous, distributed and/or complex, with different hardware and/or software architectures and/or with software application workflows spread out across different hosts in a network, for example. The World Wide Web (or simply the Web), provided by the Internet, for example, is growing rapidly, at least in part, from the large amount of content being added on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like.

Additionally, as also mentioned above, computing devices, such as IoT-type devices, for example, may incorporate a variety of processing circuits including general-purpose central processing units (CPU) and/or microcontrollers, machine learning (ML) accelerators, graphics processing units (GPU), etc. ML, for example, appears to be increasingly prevalent throughout the computing industry. To address this surge of interest in ML, more and more systems appear to be including hardware-based ML accelerators and/or the like. For example, more and more systems appear to be including neural processing units (NPU). Further, processors (e.g., CPUs, GPUs, NPUs, ML accelerators, etc.) may incorporate a number of execution cores of varying capabilities, for example. In some instances, challenges may be faced in developing software applications capable of improved performance, efficiency and/or security, for example, across such a variety of execution environments and/or circumstances.

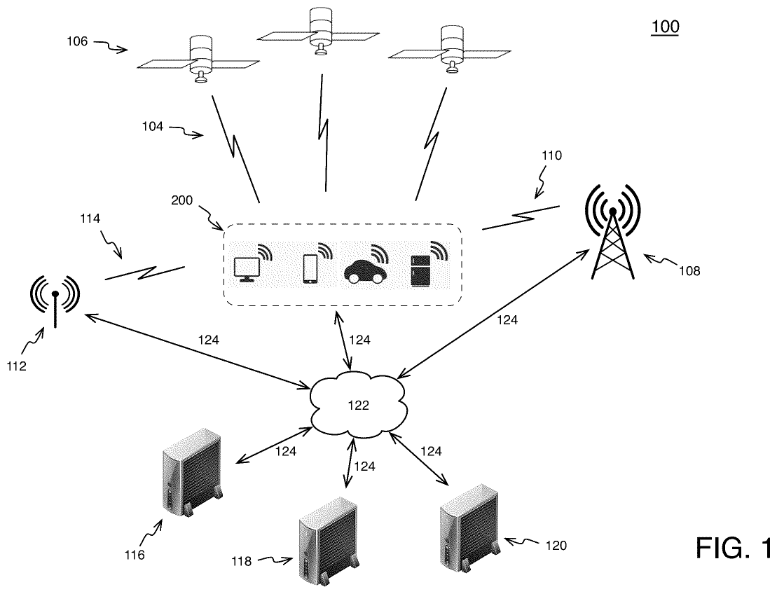

FIG. 1 is a schematic diagram illustrating features associated with an implementation of an example operating environment 100 capable of facilitating and/or supporting one or more operations, processes, techniques, approaches, etc. for runtime linking of software component functions, for example. It should be appreciated that operating environment 100 is described herein as a non-limiting example that may be implemented, in whole or in part, in a context of various wired and/or wireless communications networks and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks and/or the like. It should also be noted that claimed subject matter is not limited to a particular network and/or operating environment. Thus, for a particular implementation, one or more operations, processes, techniques, approaches, etc. for sharing machine learning models may be performed, at least in part, in an indoor environment and/or an outdoor environment, or any combination thereof.

Thus, as illustrated, in a particular implementation, one or more client computing devices 200, such as IoT-type devices, may, for example, receive and/or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 1006 may be from any one several regional navigation satellite systems (RNSS) such as, for example, WAAS, EGNOS, QZSS, just to name a few examples.

At times, one or more client computing devices 200 may, for example, transmit wireless signals to and/or receive wireless signals from a suitable wireless communication network. In one example, one or more client computing devices 200 may communicate with a cellular communication network, such as by transmitting wireless signals to and/or receiving wireless signals from one or more wireless transmitters capable of transmitting and/or receiving wireless signals, such as a base station transceiver 108 over a wireless communication link 110, for example. Similarly, one or more client computing devices 200 may transmit wireless signals to and/or receive wireless signals from a local transceiver 112 over a wireless communication link 114, for example. Base station transceiver 108, local transceiver 112, etc. may be of the same or similar type, for example, and/or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more client computing devices 200 at a shorter range over wireless communication link 114 than at a range established via base station transceiver 108 over wireless communication link 110. For example, local transceiver 112 may be positioned in an indoor or like environment and/or may provide access to a wireless local area network (WLAN, e.g., IEEE Std. 802.11 network, etc.) and/or wireless personal area network (WPAN, e.g., Bluetooth® network, etc.). In another example implementation, local transceiver 112 may comprise a femtocell and/or picocell capable of facilitating communication via link 114 according to an applicable cellular or like wireless communication protocol. Again, it should be understood that these are merely examples of networks that may communicate with one or more client computing devices 200 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more client computing devices 200, base station transceiver 108, local transceiver 112, etc. may, for example, communicate with one or more servers, referenced herein at 116, 118, and 120, over a network 122, such as via one or more communication links 124. Network 122 may comprise, for example, any combination of wired and/or wireless communication links. In a particular implementation, network 122 may comprise, for example, Internet Protocol (IP)-type infrastructure capable of facilitating or supporting communication between one or more client computing devices 200 and one or more servers 116, 118, 120, etc. via local transceiver 112, base station transceiver 108, directly, etc. In another implementation, network 122 may comprise, for example cellular communication network infrastructure, such as a base station controller and/or master switching center, to facilitate and/or support mobile cellular communication with one or more client computing devices 200. Servers 116, 118 and/or 120 may comprise any suitable servers or combination thereof capable of facilitating or supporting one or more operations, processes, techniques, approaches, etc. discussed herein. For example, servers 116, 118 and/or 120 may comprise one or more update servers, back-end servers, management servers, archive servers, location servers, positioning assistance servers, navigation servers, map servers, crowdsourcing servers, network-related servers, or the like.

Even though a certain number of computing platforms and/or devices are illustrated herein, any number of suitable computing platforms and/or devices may be implemented to facilitate and/or support one or more operations, processes, techniques, approaches, etc. associated with operating environment 100. For example, at times, network 122 may be coupled to one or more wired and/or wireless communication networks (e.g., WLAN, etc.) so as to enhance a coverage area for communications with one or more client computing devices 200, one or more base station transceivers 108, local transceiver 112, servers 116, 118, 120, or the like. In some instances, network 122 may facilitate and/or support femtocell-based operative regions of coverage, for example. Again, these are merely example implementations, and subject matter is not limited in this regard.

In this context, “IoT-type device” and/or the like refers to one or more electronic and/or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing may be embedded into hardware so as to facilitate and/or support devices' ability to acquire, collect, and/or communicate content over one or more communications networks, for example, at times, without human participation and/or interaction. Client computing devices 200, which may, for example, include one or more IoT-type devices, may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, notebook computers, personal entertainment systems, tablet devices, personal computers (PCs), personal audio and/or video devices, personal navigation devices, and/or the like, to name a few non-limiting examples. Typically, in this context, a “mobile device” and/or the like refers to an electronic and/or computing device that may from time to time have a position or location that changes. “Stationary device” and/or the like refers to a device that may have a position or location that generally does not change. In some instances, client computing devices 200, such as IoT-type devices, may be capable of being identified, such as uniquely, via an assigned Internet Protocol (IP) address, as one particular example, and/or having an ability to communicate, such as receive and/or transmit electronic content, for example, over one or more wired and/or wireless communications networks.

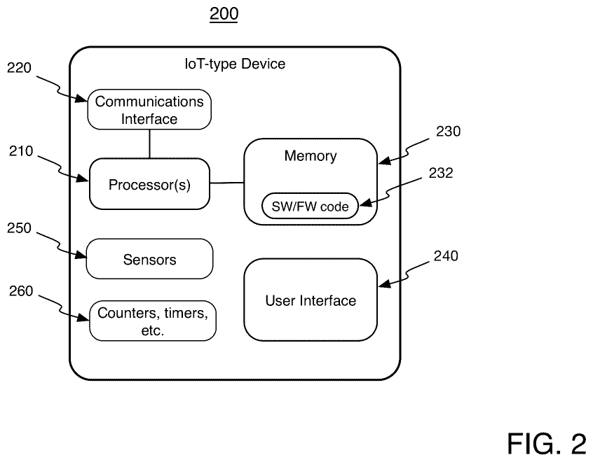

FIG. 2 is an illustration of an embodiment 200 of an example IoT-type device. Of course, subject matter is not limited in scope to the particular configurations and/or arrangements of components depicted and/or described for example devices mentioned herein. In an embodiment, IoT-type device 200 may comprise one or more processors, such as processor(s) 210, and/or may comprise one or more communications interfaces, such as communications interface 220. In implementations, processor(s) 210 may include one or more central processing units (CPU), graphics processing units (GPU), machine-learning (ML) accelerators, microcontrollers, neural processing units (NPU), etc., to name a few non-limiting examples. Also, processor(s) 210 may include one or more execution cores. For example, processor(s) 210 may include multiple execution cores of varying characteristics and/or capabilities, in implementations. Also, in implementations, processor(s) 210 may comprise a system on chip (SoC), for example. In an embodiment, one or more communications interfaces, such as communications interface 220, may enable wireless communications between an electronic device, such as IoT-type device 200, and one or more other electronic devices (e.g., IoT-type device, server computing device, etc.). In an embodiment, wireless communications may occur substantially in accordance any of a wide range of communication protocols, such as those mentioned herein, for example.

In a particular implementation, IoT-type device 200 may include a memory, such as memory 230. In a particular implementation, memory 230 may comprise a non-volatile memory, for example. Further, in a particular implementation, a memory, such as memory 230, may have stored therein executable instructions, such as for one or more operating systems, communications protocols, and/or applications, for example. A memory, such as 230, may further store particular instructions, such as software and/or firmware code 232, that may be updated from time to time, for example. Further, in a particular implementation, a client computing device, such as IoT-type device 200, may comprise a user interface, such as user interface 240, and/or one or more sensors, such as one or more sensors 250. As utilized herein, “sensors” and/or the like refer to a device and/or component that may respond to physical stimulus, such as, for example, heat, light, sound pressure, magnetism, particular motions, etc., and/or that may generate one or more signals and/or states in response to physical stimulus. Example sensors may include, but are not limited to, one or more accelerometers, gyroscopes, thermometers, magnetometers, barometers, light sensors, proximity sensors, hear-rate monitors, perspiration sensors, hydration sensors, breath sensors, cameras, microphones, etc., and/or any combination thereof.

In particular implementations, IoT-type device 200 may include one or more timers and/or counters and/or like circuits, such as circuitry 260, for example. In an embodiment, one or more timers and/or counters and/or the like may track one or more aspects of device performance and/or operation.

Although FIG. 2 depicts a particular example implementation of a client computing device, such as IoT-type device 200, other embodiments and/or implementations may include other types, configurations, arrangements, etc. of electronic and/or computing devices. As mentioned, example types of devices may include, but are not limited to, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, notebook computers, personal entertainment systems, tablet devices, personal computers (PCs), personal audio and/or video devices, personal navigation devices, or any combination of the foregoing.

In some circumstances, processors, such as SoC processors, for example, may be implemented from multiple interacting components having different architectures and/or microarchitectures and/or with fixed function and/or programmable accelerators, for example, providing a wide range of possible execution environments for software applications. For example, some systems may be implemented with multiple instances of different configurations of execution cores (e.g., big and LITTLE cores, each having different potential microarchitecture advantages) and/or may also be implemented to include one or more scalable matrix extension accelerators, GPUs, NPUs, microcontrollers for system management, cores for wireless communication, etc. Thus, for example, computing systems, including IoT-type devices, may include a wide range of architecture types, processor types, execution core types, etc.

Also, in some circumstances, the types of systems, components, etc. that may execute a particular software application may be largely fixed. However, as software applications become more rich and/or as multiple applications are executed concurrently more frequently (e.g., to perform video conferencing while executing a game with 3D graphics, realistic physics and/or ML-controlled characters), and/or given the wide range of possible architecture types, processor types, execution core types, for example, it may become more difficult to determine what computing resources will be available to execute such applications. Therefore, software may be developed with capabilities to have different sections of an application executed on different system components based on a particular availability of resources. In mobile computing and/or with IoT-type devices, for example, computing resources may oftentimes be relatively limited. Because performance and/or efficiency may be emphasized in mobile and/or IoT-type computing, it may be advantageous to transition to different software component implementations as software components are deployed on particular hardware components and/or systems. It may also be advantageous to transition to different software component implementations as a result of changing system goals (e.g., power efficiency while on battery versus performance when plugged in) and/or due to a new application being started with conflicting resource demands, for example.

In some circumstances, software may not be developed to operate advantageously in such dynamic environments. Generally, software components (e.g., applications) may be developed as one-size-fits-all binaries (e.g., executable components) intended to be run on a variety of systems. Such applications, for example, may generally not be targeted (e.g., adapted, optimized, etc.) for performance or efficiency for particular execution environments and/or may also generally not be able to adapt to changing execution environments.

As described more fully below, it may be advantageous to develop an approach, mechanism, etc. to select more advantageous software component implementations at a block and/or function level, for example, based at least in part on characteristics of a particular computing device and/or available computing resources and/or based at least in part on particular policy parameters (e.g., pertaining to performance, power efficiency, security, privacy, quality of service, etc.). It may further be advantageous to offload particular operations, such as at the function and/or block level, to cloud-based services, for example, in some circumstances, such as when local resources are not available and/or are not sufficient. This example use-case may gain increasing importance with the growth of disaggregated intelligent resources such as data processing units (DPU) and/or computational storage devices (CSD) in data centers, for example. It may further be advantageous to offload particular operations, such as at the block and/or function level, to edge-type computing devices in circumstances wherein mobile and/or IoT-type devices may have relatively limited computing resources, for example.

As discussed more fully below, embodiments may include replacing a dynamic linker utilized in a number of example operating systems, for example, with a new approach to dynamic linking that may be directed to more relatively finely-grained lazy linking (e.g., linking of software components during runtime) to allow selection of a more advantageous particular implementation of a function and/or block of a plurality of implementations depending at least in part on a particular hardware configuration and/or based at least in part on specified goal and/or policy parameters (e.g., pertaining to security, privacy, power efficiency, reliability, etc.).

As discussed more fully below, embodiments may include developing a software component (e.g., software application) that may include options for lazy linking (e.g., particular code is not incorporated into the application binary until runtime). In embodiments, during runtime for the software component, a linking component (e.g., dynamic linker activated via lazy linking) may be invoked responsive at least in part to a function call. Further, for example, one or more aspects and/or characteristics of the running system and/or device and/or of a current execution environment may be determined. In implementations, knowledge about the particular running system and/or device and/or of a current execution environment may be cross-referenced with user and/or system specified goals and/or policies to select a particular implementation of the particular called function from among a plurality of possible implementations of the particular function. For example, a number of different implementations of a particular function may be stored in a data structure. Each of the implementations may be directed to execution on different respective execution environments, including different hardware configurations, and/or directed to realizing different specified policies and/or goals. Based on the particular running system and/or execution environment and/or based on the specified goals and/or policies, a particular implementation may be selected and retrieved from the data structure. The particular implementation may be executed and the results of the function call may be returned and the software component may continue to be executed, for example. Further, in implementations, as the software component continues to be executed during runtime, a subsequent call to the same particular function may result in the same particular selected implementation being executed without having to go through the exercise of selecting an appropriate and/or more advantageous implementation. In other implementations, subsequent selection processes may be performed responsive to subsequent function calls to help ensure that more advantageous implementations are executed whenever the function is called. This may allow the software component (e.g., software application) to adapt, at a function and/or block level, during runtime to changing circumstances (e.g., changing execution environment, changing resource availability, changing policy specifications, etc.), thereby addressing, at least in part, the example challenges and/or issues mentioned above.

Although implementations are discussed herein in terms of function call and/or functions, subject matter is not limited in scope in these respects. For example, the term “block” and/or the like may be synonymous with “function,” and the terms may be utilized interchangeably. Further, “function,” “block” and/or the like refer to a section of executable code comprising a routine, subroutine, etc. that operates on one or more inputs (e.g., signals and/or states) to generate one or more outputs (e.g., signals and/or states).

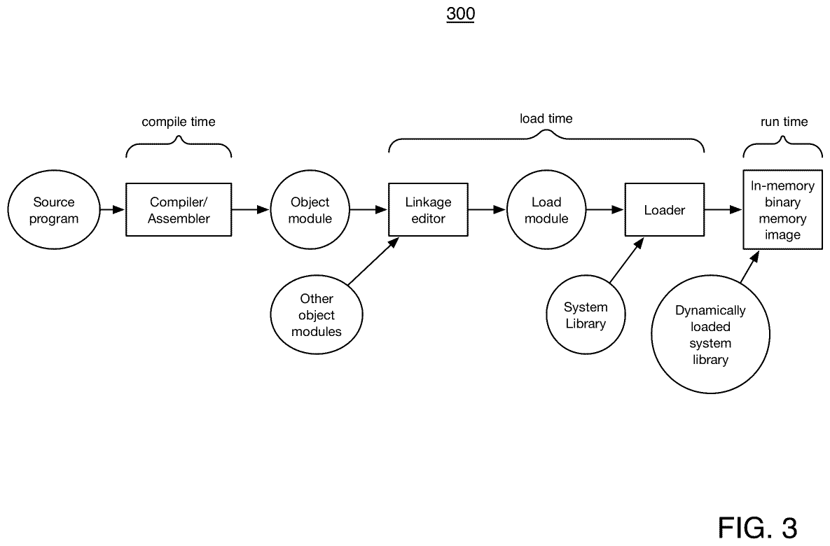

FIG. 3 depicts a schematic block diagram depicting an example software component compilation approach (e.g., example process 300). As depicted in FIG. 3, example compilation process 300 may include compiling a source program at compile time and/or build time to generate an object module. Other object modules may be linked to the source program object module via a linkage editor at load time, for example. System-provided libraries may also be loaded during load time as part of an initial compilation process, such as example process 300. In some circumstances, such libraries may be dynamically linked, with the actual implementation of the linked libraries not incorporated into the application binary until the application is executed (e.g., at run time). In some circumstances, particular functions may not be determined until the particular function is invoked during run time. This may be referred to as “lazy,” “late” and/or “dynamic” binding. For example, in the C++ programming language, late binding (also referred to as lazy and/or dynamic binding) refers to what normally happens when a virtual keyword is used in a program's declaration. A C++ compiler, for example, may create a virtual table (e.g., a look-up table) for such functions that may be consulted when the functions are called. In some circumstances, the table structure may be implemented in a binary structure of an application in particular sections of a particular binary application format. For example, for an ELF binary format, a procedure linkage table (PLT) and/or a global offset table (GOT) may be included in an application binary. As mentioned, “binary” and/or the like refers to an executable format (e.g., compiled) of a software component (e.g., software application).

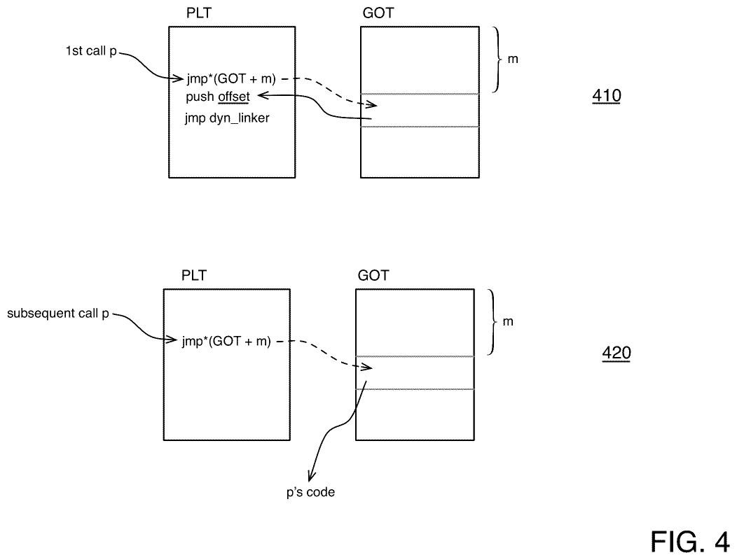

FIG. 4 is an illustration depicting an example software component linking approach including an example PLT and an example GOT. In implementations, a GOT may comprise a section of a software application binary that enables the application to run independent of where the application may be loaded in memory by providing a level of indirection for program symbols. In implementations, program symbols may represent instructions or data (e.g., signals and/or states), with their locations expressed as an offset from the start of the binary rather than as an absolute memory location. In implementations, an operating system's dynamic linker may update the GOT at application startup and/or as symbols are accessed, thereby enabling the use of shared libraries and/or late binding. As utilized herein, “binding” and “linking” are synonymous and may be utilized herein interchangeably.

Additionally, in implementations, dynamically linked binaries may resolve external function calls (e.g., function calls that may require linking of a software component not part of the application binary) via the PLT. In implementations, the PLT may contain an entry for each external function reference. For example, when a particular function is first called, execution may jump into an entry of the GOT. For example, as depicted at example 410 of FIG. 4, when a procedure “p” is first called, the PLT entry for procedure p may refer to an offset “m” into the GOT. Initially, this particular entry may contain the address of the instruction following the previous jump, as again depicted at example 410. This approach may be referred to as “trampolining.” As further indicated at example 410, the particular instruction following the previous jump may indicate an instruction to push some content (e.g., signals and/or states representative of the PLT offset) on the stack and then a jump may be made to a dynamic linker's resolution function. In implementations, a dynamic linker's resolution function may be referred to as procedure “dl_runtime_resolve” although subject matter is not limited in scope in this respect. In implementations, the call to dl_runtime_resolve may comprise an additional indirect jump into the GOT.

In implementations, the first several (e.g., three) entries of the GOT may be reserved and/or may be filled in by the dynamic linker upon program startup. In implementations, GOT[0] may store an address of the program's .dynamic segment. This particular segment may hold a number of pointers to other parts of the ELF binary file. For example, the particular .dynamic segment may serve as a guide of sorts for a dynamic linker to navigate the ELF binary file. Further, in implementations, GOT[1] may comprise a pointer to a data structure that may be managed by the dynamic linker. This particular data structure may comprise a linked list of nodes corresponding to the symbol tables for each shared library linked with the program. When a symbol is to be resolved by the dynamic linker, the list may be traversed to find the appropriate symbol, for example. In implementations, using a LD_PRELOAD environment variable may help ensure that a preload library may be the first node on this list. Further, in implementations, GOT[2] may store the address of the symbol resolution function within the dynamic linker. For the current example, such as depicted at example 410 in FIG. 4, GOT[2] may store the address of the function named dl_runtime_resolve, which may essentially comprise an assembly stub that may perform some register/stack setup and/or that may call into a function (e.g., a C function) called dl_fixup( ) In implementations, a function labelled dl_fixup may comprise a function that resolves the particular symbol in question (e.g., function “p”).

In implementations, responsive at least in part to the particular symbol's address being found, the program's GOT entry for it may be patched. In implementations, such patching may be performed by dl_fixup( ) although subject matter is not limited in scope in this respect. Once dl_fixup( ) patches the correct GOT entry, the next time the function is called, it will again jump to the PLT entry, but this time the indirect jump there will go to the symbol's address instead of the following instruction. This is illustrated at example 420 of FIG. 4. In some circumstances, this example approach of lazy/late symbol resolution (e.g., waiting until a function is called before resolving the function's symbol) may help to avoid relatively resource-intensive lookups for functions that may not be called, for example. In some implementations, the dynamic linker may be forced to eagerly resolve symbols upon program startup by setting an LD_BIND_NOW variable, for example.

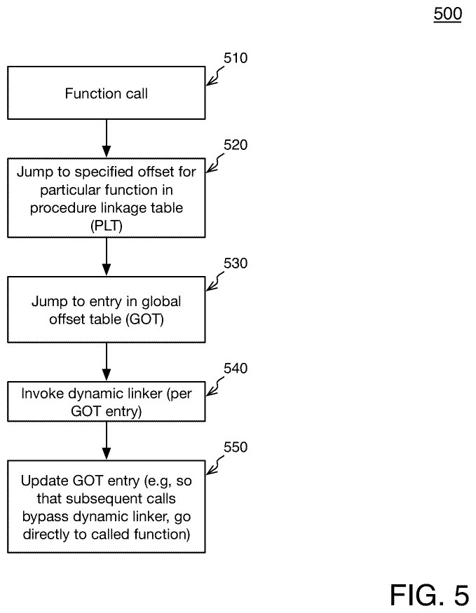

FIG. 5 is a flow chart depicting an example software component linking process. Embodiments may include all of the operations described, fewer than the operations described, and/or more than the operations described for example process 500. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

Example process 500 may comprise a restatement of the example approach described above in connection with example 410 of FIG. 4. For example, as depicted at block 510, a function call may be made during runtime of a particular software component (e.g., software application binary). Further, as depicted at block 520, a jump may be performed to a specified offset for the particular called function within a first table, such as a PLT. In implementations, the particular entry of the PLT associated with the particular called function may indicate a jump to a particular entry of a second table, such as a GOT, as indicated at block 530. Further, for example, a dynamic linker may be invoked, as indicated at block 540, and a GOT entry may be updated so that subsequent calls to the same particular function may bypass the dynamic linker and may instead go directly to the called function, similar to what is shown in example 420 of FIG. 4, for example.

The techniques and/or mechanisms described above may represent an example approach to lazy linking of particular functions responsive to runtime function calls. Embodiments described below may include at least some aspects of these example techniques and/or mechanisms. However, with embodiments such as those described below, key differences may provide significant advantages and/or benefits.

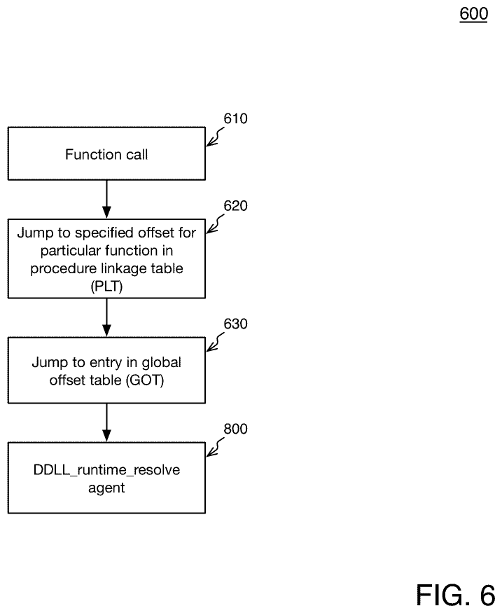

FIG. 6 is a flow chart illustrating an example software component dynamic linking process 600, in accordance with an embodiment. In implementations, the “dl_runtime_resolve” function mentioned above in connection with the example approaches, techniques and/or mechanisms of FIGS. 4 and 5, for example, may be replaced with executable code that may select a particular implementation of a called function from among a plurality of possible implementations. For example, as depicted in example process 600, a function call may be made during runtime of a particular software component, as indicated at block 610. As also indicated at block 620, a jump may be performed to a specified offset for the particular called function within a first table, such as a PLT, for example. In implementations, the particular entry of the PLT associated with the particular called function may indicate a jump to a particular entry of a second table, such as a GOT, for example, at indicated at block 630. At block 800, however, rather than calling the dl_runtime_resolve function, as would be the case in the examples of FIGS. 4 and 5, a different software component (e.g., DDLL_runtime_resolve) may be executed.

For example, a software developer may develop two or more different implementations of a particular function. In implementations, each of the different implementations may be developed with particular hardware configurations, computing resources and/or policy parameters in mind. For example, a first implementation may be developed with significant computing resources in mind and/or with performance as a priority. A second implementation, for example, may be developed with relatively meager computing resources in mind and/or with reduced power consumption as a priority. Of course, these are merely example types of implementations that may be developed with particular hardware configurations, computing resources and/or policy parameters in mind, and subject matter is not limited in scope in these respects. At runtime, responsive at least in part to a determination that a call to a particular procedure has been made, a particular software component, such as DDLL_runtime_resolve, may be executed to determine which of a plurality of particular implementations of the called function to run.

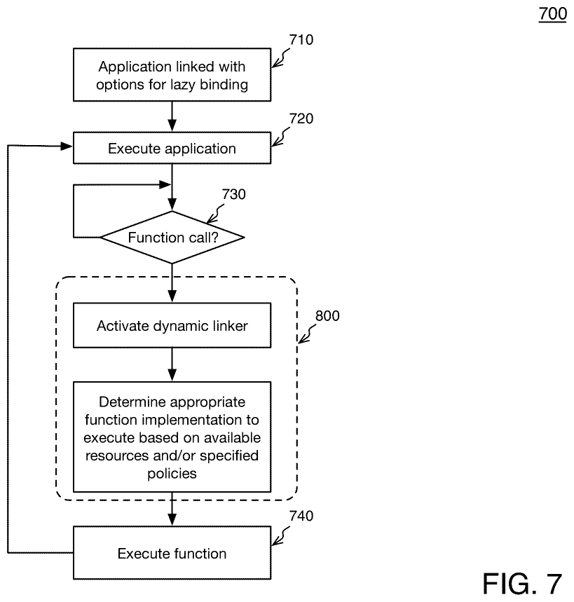

FIG. 7 is a flow chart depicting example software component dynamic linking process 700, in accordance with an embodiment. Embodiments may include all of the operations described, fewer than the operations described, and/or more than the operations described for example process 700. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

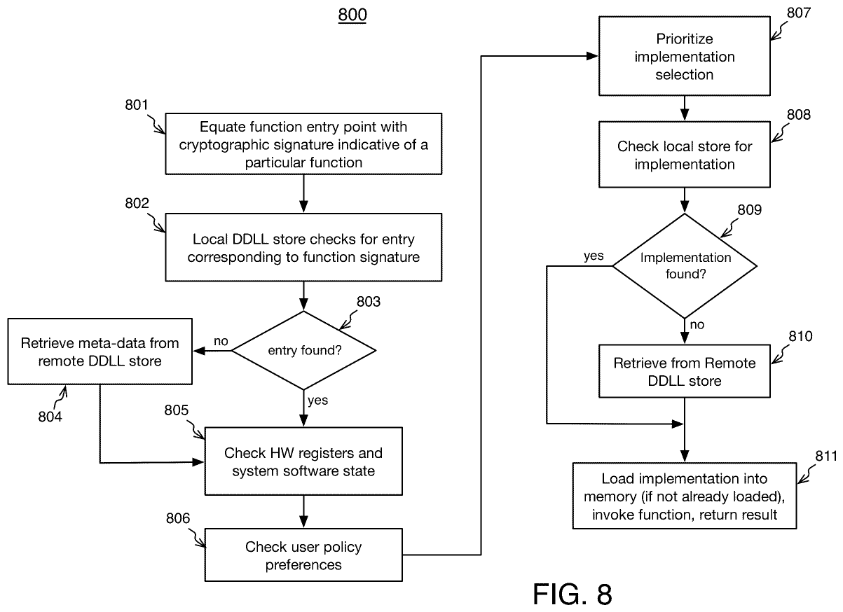

Generally, for example, a software application that may be linked with options for lazy binding may be developed, as indicated at block 710. At block 720, for example, the software application may be executed and at block 730, for example, a particular function call may occur during application runtime. Responsive at least in part to the particular function call depicted at block 730, a dynamic linking component, such as DDLL_runtime_resolve, may be invoked, activated and/or initiated, for example, as indicated at block 800. Note that block 800, seen also in FIG. 6, for example, is discussed more fully below in connection with FIG. 8.

In implementations, an example dynamic linking component, such as DDLL_runtime_resolve, may determine an appropriate function implementation to execute based at least in part on available computing resources and/or based at least in part on one or more specified policies and/or policy parameters, as indicated at block 800. For example, DDLL_runtime_resolve may cross-reference a possible set of implementations with a policy that may help determine which implementation to execute. For example, for a policy emphasizing performance, the DDLL_runtime_resolve component may select an implementation of a particular procedure that may result in advantageous performance for the particular processor that is currently executing the particular software application making the procedure call. Other implementations of the particular procedure may be directed to more efficient power usage, improved reliability, improved security and/or improved privacy, to name but a few non-limiting examples.

For example process 700, the particular selected function implementation may be executed at block 740. In implementations, the software component may continue to be executed at block 720. For subsequent calls to the same function as previously called, the same selected implementation may be executed, thereby eliminating the need to perform additional dynamic linking and/or implementation selection operations. However, in other implementations, for subsequent calls to the same function, the dynamic linker component may be activated so that a particular implementation of the called function may be selected anew. This may allow for adaptation to a changing execution environment, for example, such as a change in available computing resources and/or a change in policy.

Another difference between embodiments described herein, such as described in connection with FIGS. 6, 7, 8, 9 and/or 10, for example, and other approaches may be that with other approaches the dl_runtime_resolve agent, for example, may reference tables in a file system which may point to different directories where a library implementation might live. Such approaches may keep the resolution at a library file level. By keeping resolution at a library file level, it may prove more challenging for a system to respond advantageously to a changing execution environment and/or to changing policy specifications, for example.

For example embodiments and/or implementations described herein, such as described in connection with FIGS. 6, 7, 8, 9 and/or 10, for example, however, functionality may be extended to function-level granularity resolution. By extending granularity to the function level, a computing device, such as an IoT-type device 200, may have an ability to respond advantageously to changing execution environment and/or changing policy specifications, for example. In networked systems, such as on the edge or in the cloud, for example, mapping may be maintained in a distributed database along with potential function implementations so that potential implementations don't all have to exist on the storage of an otherwise constrained node or ephemeral virtual machine, for example.

In implementations, when referenced, a dynamic linking agent, such as DDLL_runtime_resolve, for example, may pull an appropriate function implementation from a distributed database into a local cache for execution and/or for potential future re-execution, for example. That is, rather than operating with the granularity of an entire root filesystem, implementations may operate at the granularity of a function, for example.

FIG. 8 is a flow chart illustrating an example process 800 for selecting a particular implementation of a particular function, in accordance with an embodiment. Embodiments may include all of the operations described, fewer than the operations described, and/or more than the operations described for example process 800. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

In the discussion to follow, several modules may be described, including the aforementioned dynamic linker runtime resolution component (DDLL_runtime_resolve), a local store (e.g., local DDLL store) and/or a remote store (e.g., remote DDLL store), for example.

For example process 800, executed at least in part on one or more processors of a computing device, such as processor(s) 210 of IoT-type device 200, for example, a software application may be running on the system. In an implementation, the software application may invoke a function that may be part of a DDLL backend library, for example. Similar to what may be indicated at example process 600 discussed above, a control flow during runtime of the particular software application may switch to a PLT code segment that may indirect the function entry point through the GOT to store the function entry point, for example. Also, for example, the DDLL_runtime_resolve component may be invoked. In implementations, the DDLL_runtime_resolve component may equate the function entry point with a cryptographic function signature that may represent a specific version of the invoked (e.g., called) function, as indicated at block 801. In an implementation, the version of a function may represent the function type signature (e.g., the type of the arguments and the return type) as well as expected functionality at the time the code was compiled (for example the original source code of the function rather than the compiled implementations). In implementations, the invoked DDLL_runtime_resolve component may then check a local DDLL store for function implementations. For example, the local DDLL store may check to see if it has an entry corresponding to the function signature, as indicated at block 802. Further, as indicated at block 803, if no entry corresponding to the function signature is found, meta-data pertaining to the called function may be retrieved from a remote DDLL store that may be specified via system configuration parameters, for example.

Further, in implementations, if a corresponding entry is found and/or responsive at least in part to the acquisition of meta-data from a remote DDLL store, the DDLL_runtime_resolve agent, for example, may check hardware registers and/or a system software state, as indicated at block 805, as well as system and/or user policy preferences, as indicated at block 806, to determine a prioritization of which of a possible plurality of function implementations to utilize to execute the called function, as indicated at block 807.

Responsive at least in part to the prioritization performed at block 807, the DDLL_runtime_resolve component, executed by processor 210 of IoT-type device 200, for example, may check a local DDLL store (e.g., stored in memory 230 of IoT-type device 200) for a particular selected implementation. As indicated at blocks 809 and 810, for circumstances in which the local DDLL store does not currently hold a prioritized and/or otherwise selected function implementation, the particular implementation may be obtained from a remote DDLL store, such as via a cloud-based resource, for example. In implementations, the DDLL_runtime_resolve component may download the particular selected and/or prioritized function implementation from a remote DDLL store or from an indirect location URI specified in the retrieved metadata.

Further, as indicated at block 811, the particular implementation may be loaded into memory (if not already loaded), the implementation may be invoked and/or a result may be returned to the original control flow.

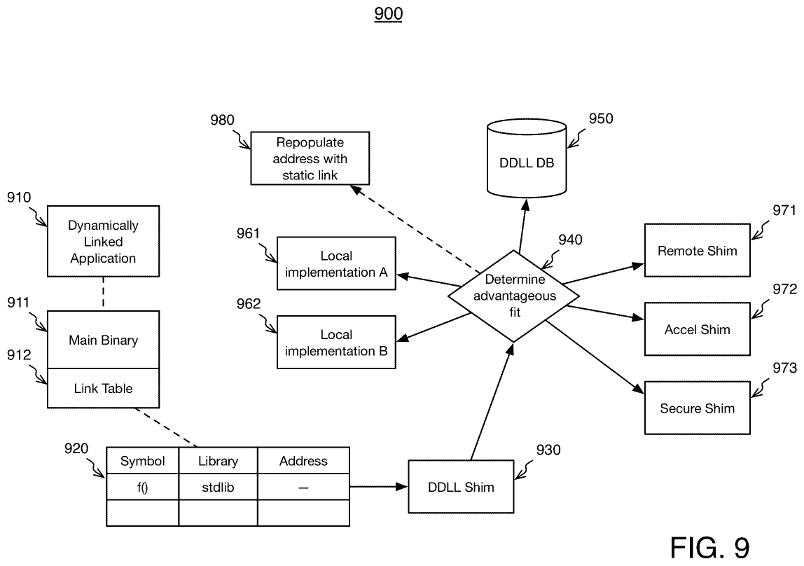

FIG. 9 is a schematic block diagram illustrating an example approach 900 for dynamically linking particular implementations of particular functions, in accordance with an embodiment. Example 900 may illustrate a number of aspects of various implementations and/or embodiments mentioned above. For example, block 910 depicts a representation of an example dynamically linked software application. In implementations, a particular software application may be executed at one or more processors, such as processor(s) 210, of a computing device, such as IoT-type device 200. Also, in implementations, the particular software application of block 910 may incorporate a main binary section 911 and may also incorporate one or more tables, such as tables 912 and/or 920, for example, which, for particular implementations, may correspond to PLT and/or GOT tables such as discussed above in connection with FIG. 4, for example.

Further, for example, block 930 of example approach 900 may comprise a software component referred to as a DDLL shim that may be invoked upon an external procedure call during runtime of the particular software component of block 910. In an implementation, DDLL shim 930 may comprise at least some characteristics of the DDLL_runtime_resolve component mentioned above. For example, as indicated at block 940, responsive at least in part to a particular procedure call during runtime of the dynamically linked application of block 910, a determination may be made as to which of a plurality of implementations for a particular procedure may comprise a more advantageous fit for a particular set of circumstances.

For example, a particular implementation of a particular function called by the software application during runtime may be prioritized based at least in part on hardware and/or system software registers. In an implementation, it may be relatively straightforward to prioritize an implementation that may be developed (e.g., configured, optimized, etc.) with a particular core microarchitecture in mind. In some circumstances, existing software distributions may direct software component development to advantageous performance for either no microarchitectural features or a single microarchitecture. This may be the case even on systems with multiple microarchitectures.

In implementations, for circumstances in which a processor may incorporate two or more different execution cores, for example, different implementations of a particular function that may be linked to a software application during runtime may be directed to providing advantageous performance for each of the respective different execution cores. For example, a first implementation may provide improved performance on a particular execution core type and a second implementation may provide improved performance when executed on a second particular execution core type. Further, for example, different libraries of functions may be implemented for different execution core types. For example approach 900, a first implementation corresponding to a first particular execution core type may be indicated at block 961 and a second implementation corresponding to a second particular execution core type may be indicated at block 962. In an implementation, function implementations 961 and/or 962 may be stored in a local data structure, such as may be stored in memory 230 of IoT-type device 200, for example.

In implementations, the type of execution core currently being used to execute a particular software application and/or a particular called function may be determined by reading the contents of a particular hardware register. Also, particular implementations in a DDLL store, such as DDLL DB 950, may be annotated with identifiers indicating for which CPU, NPU, GPU, execution core, etc., they were developed (e.g., configured, optimized, etc.). In some circumstances, there may be multiple levels to identification of a particular CPU. In implementations, a decision of prioritization may follow a most-exact match style algorithm, thereby allowing fuzzier selection of a particular implementation. In some implementations, a primary part number may be all that is need to identify one or more microarchitectural features for which an implementation of a function may be configured, optimized, etc.

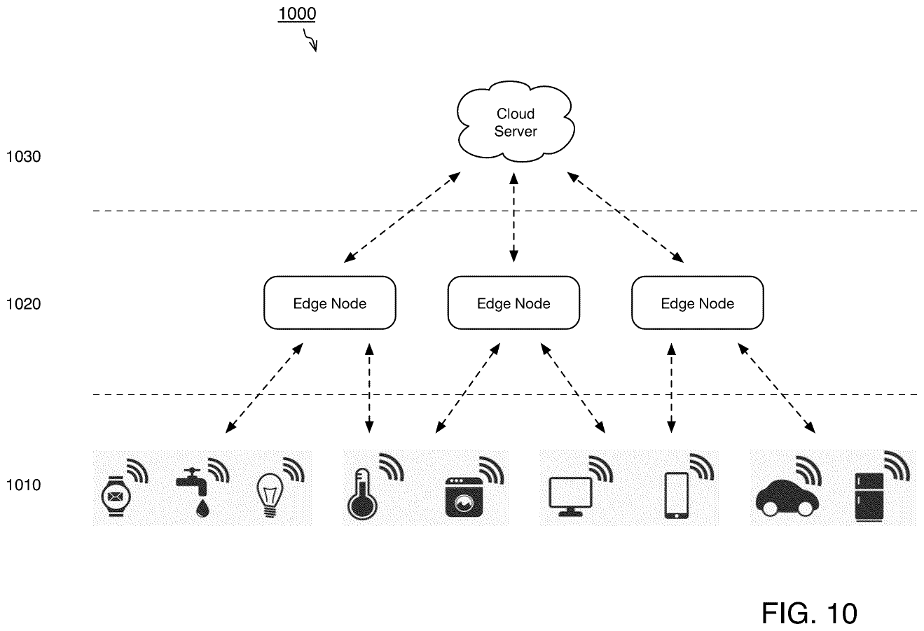

Also, in implementations, a software component, such as DDLL_runtime_resolve, may determine that a particular called function and/or a particular implementation of a function may be more advantageously performed on a different system than the computing device from which it was initially invoked. For example, a particular function implementation may be more advantageously performed on a system having a ML accelerator. In implementations, an accel shim, indicated by block 972, for example, may task a ML accelerator (e.g., NPU) that may reside on an edge-type computing device (see FIG. 10, for example) and/or at a cloud-based computing resource (again, see FIG. 10) to run the particular implementation.

In implementations, to determine on which computing resource a particular implementation of a particular procedure may run more advantageously, workload characterization for the particular function for different computing resources may be stored as part of the meta-data to be retrieved for the particular function and/or function implementation. In implementations, such a workload characterization may be used by DDLL_runtime_resolve, for example, to determine which of the available system resources may be beneficially utilized to perform particular function implementations. In the case of fixed function accelerators, this may involve invoking a shim, such as remote shim 971, that may offload a particular implementation of a particular function to a remote accelerator. Similarly, a shim, such as secure shim 973, may offload a particular implementation of a particular function to a particular processor, remote or local, that may be primarily directed to execution of security protocols and/or procedures, for example.

FIG. 10 depicts a schematic block diagram depicting an example edge computing environment 1000, in accordance with an embodiment. Generally, “edge computing” and/or the like refers to a distributed computing approach that may bring computation and/or content storage closer to sources of content (e.g., signals and/or signal packets). Stated otherwise, edge computing may comprise computing that takes place at or near the physical location of the source(s) of content. Example sources of content may include sensors, such as example sensors 250 associated with IoT-type devices 200 mentioned above. By locating computation and/or storage resources physically closer to content sources, it is expected that latencies may be improved and/or that bandwidth utilization may be reduced. Reliability may also be improved in at least some circumstances.

For one example of an edge computing use case, consider a manufacturing plant. On a factory floor, a relatively large number of IoT-type sensors may generate a stream of signals and/or signal packets that may be utilized to prevent breakdowns and/or to otherwise improve operations. In such circumstances, it may be quicker and perhaps less costly to process the generated stream of signals and/or signal packets utilizing computational resources physically located close to the sensors rather than transmit the stream of signals and/or signal packets to a remote data center, for example.

Another example use case may include autonomous vehicles. Such vehicles tend to generate relatively large amounts of content (e.g., signals and/or signal packets) from the many sensors onboard. Due at least in part to the relatively large amount of content generated relatively continuously, autonomous vehicles may process sensor signals and/or signal packets onboard rather than transmit the signals and/or signal packets to a remote computing resource. By processing such content onboard, autonomous vehicles may avoid the relatively longer latencies that would otherwise be experienced as a result of relying on transmissions to and from a remote computing resource.

Even with the advantages that may be had in placing computing resources at or near the sources of sensor signals and/or signal packets, for example, it may be desirable to link the various sources (e.g., IoT-type devices) to a centralized computing platform so that the sources may receive software updates, share particular content, offload particular computational tasks to other systems, etc. For example, computing environment 1000 depicted in FIG. 10 may include a device layer 1010 comprising a number of IoT-type devices. In implementations, the devices of layer 1010 may have at least some characteristics similar to those of IoT-type device 200 discussed above.

In implementations, example computing environment 300 may further include an edge node layer 1020. In implementations, IoT-type devices of layer 1010 may be linked via wired and/or wireless interconnect technologies to one or more edge nodes, wherein the edge nodes may be physically located relatively close to the IoT-type devices of layer 1010. Of course, various implementations may place edge nodes at various distances from content sources (e.g., IoT-type devices, sensors, client computing devices, etc.) and subject matter is not limited in scope in these respects.

As further depicted in FIG. 10, example computing environment 1000 may include a cloud server layer 1030. For example, the edge nodes of layer 1020 may be linked via wired and/or wireless interconnect technologies to a remote computing resource, such as a cloud server. Of course, a cloud server may comprise one or more computing devices that may not be physically located at or near the edge nodes. For example, a cloud server may comprise a number of computing devices that may be located at one or more locations. Generally, a cloud server may comprise a centralized computing resource hosted over a network, such as the Internet, that may be accessed by a number of network devices including, for example, client computing devices. In some circumstances, a cloud server may be accessed by a great number of computing devices. Of course, for example computing environment 1000, the cloud server of layer 1030 may be linked to the edge nodes of layer 1020. Although the edge nodes of layer 1020 may perform computational tasks related to signals and/or signal packets obtained from IoT-type devices of layer 1010, the edge nodes of layer 1020 may at times task a cloud server, such as the cloud server depicted at layer 1030, for example, to perform computational tasks.

For example, an IoT-type device of layer 1010 may execute a particular software program. At runtime, the particular software program may invoke a particular procedure call. Responsive at least in part to the particular procedure call, a dynamic linking component, such as component 800 discussed above, may determine which of a plurality of possible implementations of the particular called function may be more advantageously executed. Such a determination may be based at least in part on the availability of particular computing resources, including, for example, computing devices from device layer 1010, edge layer 1020 and/or cloud layer 1030. As mentioned, a number of factors and/or parameters may play into a decision regarding which implementation of a particular function to execute and/or regarding which computing resources to utilize to perform the particular function implementation.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

A “signal measurement” and/or a “signal measurement vector” may be referred to respectively as a “random measurement” and/or a “random vector,” such that the term “random” may be understood in context with respect to the fields of probability, random variables and/or stochastic processes. A random vector may be generated by having measurement signal components comprising one or more random variables. Random variables may comprise signal value measurements, which may, for example, be specified in a space of outcomes. Thus, in some contexts, a probability (e.g., likelihood) may be assigned to outcomes, as often may be used in connection with approaches employing probability and/or statistics. In other contexts, a random variable may be substantially in accordance with a measurement comprising a deterministic measurement value or, perhaps, an average measurement component plus random variation about a measurement average. The terms “measurement vector,” “random vector,” and/or “vector” are used throughout this document interchangeably. In an embodiment, a random vector, or portion thereof, comprising one or more measurement vectors may uniquely be associated with a distribution of scalar numerical values, such as random scalar numerical values (e.g., signal values and/or signal sample values), for example. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

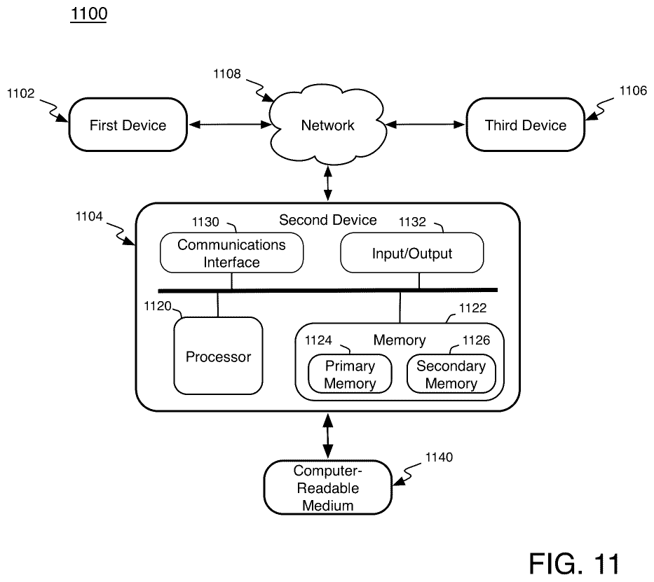

FIG. 11 is a schematic diagram illustrating an implementation of an example computing environment associated with processes to facilitate performance of particular implementations of particular functions of particular software components, according to an embodiment. In the example depicted in FIG. 11, a system embodiment may comprise a local network (e.g., device 1104 and medium 1140) and/or another type of network, such as a computing and/or communications network. For purposes of illustration, therefore, FIG. 11 shows an embodiment 1100 of a system that may be employed to implement either type or both types of networks. Network 1108 may comprise one or more network connections, links, processes, services, applications, and/or resources to facilitate and/or support communications, such as an exchange of communication signals, for example, between a computing device, such as 1102, and another computing device, such as 1106, which may, for example, comprise one or more client computing devices and/or one or more server computing device. By way of example, but not limitation, network 1108 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 11 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1-7 and in the text associated with the foregoing figure(s) of the present patent application.

Referring now to FIG. 11, in an embodiment, first and third devices 1102 and 1106 may be capable of rendering a graphical user interface (GUI) for a network device and/or a computing device, for example, so that a user-operator may engage in system use. Device 1104 may potentially serve a similar function in this illustration. Likewise, in FIG. 11, computing device 1102 (‘first device’ in figure) may interface with computing device 1104 (‘second device’ in figure), which may, for example, also comprise features of a client computing device and/or a server computing device, in an embodiment. Processor (e.g., processing device) 1120 and memory 1122, which may comprise primary memory 1124 and secondary memory 1126, may communicate by way of a communication bus 1115, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1104, as depicted in FIG. 11, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 11, computing device 1102 may provide one or more sources of executable computer instructions in the form physical states and/or signals (e.g., stored in memory states), for example. Computing device 1102 may communicate with computing device 1104 by way of a network connection, such as via network 1108, for example. As previously mentioned, a connection, while physical, may not necessarily be tangible. Although computing device 1104 of FIG. 11 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1122 may comprise any non-transitory storage mechanism. Memory 1122 may comprise, for example, primary memory 1124 and secondary memory 1126, additional memory circuits, mechanisms, or combinations thereof may be used. Memory 1122 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1122 may be utilized to store a program of executable computer instructions. For example, processor 1120 may fetch executable instructions from memory and proceed to execute the fetched instructions. Memory 1122 may also comprise a memory controller for accessing device readable-medium 1140 that may carry and/or make accessible digital content, which may include code, and/or instructions, for example, executable by processor 1120 and/or some other device, such as a controller, as one example, capable of executing computer instructions, for example. Under direction of processor 1120, a non-transitory memory, such as memory cells storing physical states (e.g., memory states), comprising, for example, a program of executable computer instructions, may be executed by processor 1120 and able to generate signals to be communicated via a network, for example, as previously described. Generated signals may also be stored in memory, also previously suggested.

Memory 1122 may store electronic files and/or electronic documents, such as relating to one or more users, and may also comprise a computer-readable medium that may carry and/or make accessible content, including code and/or instructions, for example, executable by processor 1120 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 11, processor 1120 may comprise one or more circuits, such as digital circuits, to perform at least a portion of a computing procedure and/or process. By way of example, but not limitation, processor 1120 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 1120 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 11 also illustrates device 1104 as including a component 1132 operable with input/output devices, for example, so that signals and/or states may be appropriately communicated between devices, such as device 1104 and an input device and/or device 1104 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
at least in part via a processor of a computing device during runtime of a particular software component, activating a linker component responsive at least in part to a call to a particular function specified by the particular software component;
determining, at least in part via execution of the linker component, one or more aspects of a current execution environment;
selecting a particular implementation of the particular function among a plurality of implementations of the particular function based at least in part on the one or more aspects of the current execution environment; and
executing the particular implementation of the particular function.

2. The method of claim 1, wherein the selecting the particular implementation of the particular function among the plurality of implementations of the particular function is based at least in part on the one or more aspects of the current execution environment or one or more specified policy parameters, or a combination thereof.

3. The method of claim 2, further comprising:
returning a result of the particular implementation of the particular function; and
continuing to execute the particular software component at least in part utilizing the processor of the computing device.

4. The method of claim 3, further comprising, responsive at least in part to the selecting the particular implementation of the particular function, storing a particular address corresponding to the selected particular implementation in a first table.

5. The method of claim 4, further comprising, responsive at least in part to a subsequent call to the particular function during runtime of the particular software component, executing the selected particular implementation of the particular function based at least in part on the particular address stored in the first table.

6. The method of claim 3, further comprising, responsive at least in part to a subsequent call to the particular function during runtime of the particular software component, determining, at least in part via a subsequent execution of the linker component, one or more aspects of a subsequent execution environment or the one or more specified policy parameters, or a combination thereof.

7. The method of claim 3, wherein the computing device comprises an IoT-type device and wherein the determining the one or more aspects of the current execution environment and/or the selecting the particular implementation of the particular function among the plurality of implementations in performed at least in part via an edge-type computing device coupled to the IoT-type device.

8. The method of claim 7, wherein the executing the particular implementation of the particular function comprises executing the particular implementation, at least in part, at the edge-type computing device and/or at a cloud-based computing device in communication with the IoT-type device.

9. The method of claim 2, wherein the one or more aspects of the current execution environment comprise one or more aspects pertaining to available processing resources, memory resources or communication resources, or a combination thereof, and/or wherein the one or more specified policy parameters comprise one or more parameters pertaining to power efficiency, security, privacy or quality of service, or a combination thereof.

10. The method of claim 2, wherein the plurality of implementations of the particular function are directed to be utilized advantageously in a respective plurality of particular execution environments and/or in connection with particular policy parameters.

11. An apparatus, comprising: a processor of a computing device to:
during runtime of a particular software component, activate a linker component responsive at least in part to a call to a particular function specified by the particular software component;
determine, at least in part via execution of the linker component, one or more aspects of a current execution environment;
select a particular implementation of the particular function among a plurality of implementations of the particular function based at least in part on the one or more aspects of the current execution environment; and
execute the particular implementation of the particular function.

12. The apparatus of claim 11, wherein the selection of the particular implementation of the particular function among the plurality of implementations of the particular function is based at least in part on the one or more aspects of the current execution environment or one or more specified policy parameters, or a combination thereof.

13. The apparatus of claim 12, wherein the processor further to:
return a result of the particular implementation of the particular function; and
continue to execute the particular software component.

14. The apparatus of claim 13, wherein the processor further to, responsive at least in part to the selection of the particular implementation of the particular function, store a particular address to correspond to the selected particular implementation in a first table in a memory of the computing device.

15. The apparatus of claim 14, wherein the processor further to, responsive at least in part to a subsequent call to the particular function during runtime of the particular software component, execute the selected particular implementation of the particular function based at least in part on the particular address stored in the first table.

16. The apparatus of claim 13, wherein the processor further to, responsive at least in part to a subsequent call to the particular function during runtime of the particular software component, determine, at least in part via a subsequent execution of the linker component, one or more aspects of a subsequent execution environment or the one or more specified policy parameters, or a combination thereof.

17. The apparatus of claim 13, wherein the computing device comprises an IoT-type device and wherein the processor to determine the one or more aspects of the current execution environment and/or to select the particular implementation of the particular function among the plurality of implementations at least in part by tasking an edge-type computing device coupled to the IoT-type device.

18. The apparatus of claim 17, wherein the processor to execute the particular implementation of the particular function at least in part by tasking the edge-type computing device and/or a cloud-based computing device.

19. The apparatus of claim 12, wherein the one or more aspects of the current execution environment to comprise one or more aspects to pertain to available processing resources, memory resources or communication resources, or a combination thereof, and/or wherein the one or more specified policy parameters to comprise one or more parameters to pertain to power efficiency, security, privacy or quality of service, or a combination thereof.

20. The apparatus of claim 12, wherein the plurality of implementations of the particular function are directed to be utilized advantageously in a respective plurality of particular execution environments and/or in connection with particular policy parameters.
